(19) United States
(12) Patent Application Publication
(10) Pub. No.: US 2024/0004684 A1
(43) Pub. Date: Jan. 4, 2024

(54) SYSTEM AND METHOD FOR EXCHANGING MESSAGES BETWEEN CLOUD SERVICES AND SOFTWARE-DEFINED DATA CENTERS

(71) Applicant: VMware, Inc., Palo Alto, CA (US)

(72) Inventors: Prateek GUPTA, San Francisco, CA (US); John E. BREZAK, Camano Island, WA (US); Fnu YASHU, Sunnyvale, CA (US); Alex RANKOV, Medford, OR (US); Steven MCALLISTER, Milton, GA (US); Karthik Sreenivasa MURTHY, Fremont, CA (US); George DAVELMAN, West Bloomfield, MI (US)

(21) Appl. No.: 17/853,828

(22) Filed: Jun. 29, 2022

(51) Int. Cl. G06F 9/455; G06F 9/54

(52) U.S. Cl. CPC G06F 9/45558; G06F 9/546; G06F 2009/45587; G06F 2009/4557

(57) ABSTRACT

A method of exchanging messages between a software-defined data center (SDDC) and a cloud platform through a plurality of agents deployed on an agent platform appliance that is connected to a management network of the SDDC, to enable the cloud platform to deliver cloud services to the SDDC, includes the steps of: acquiring an access token from a first agent of the plurality of agents; communicating with a message broker cloud service using the access token to exchange messages with the message broker cloud service, the exchanged messages including a first message from one of the cloud services to one or more of the plurality of agents and a second message from a second agent of the plurality of agents to one of the cloud services; and delivering the first message to the one or more agents.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX ° appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network, through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

With a large number of SDDCs, monitoring and performing operations on the SDDCs through interfaces, e.g., application programming interfaces (APIs), provided by the management software, and managing the lifecycle of the management software, have proven to be challenging. Conventional techniques for managing the SDDCs and the management software of the SDDCs are not practicable when there is a large number of SDDCs, especially when they are spread out across multiple geographical locations and in a hybrid manner.

### SUMMARY

One or more embodiments provide a cloud platform from which various services, referred to herein as “cloud services” are delivered to the SDDCs through agents of the cloud services that are running in an appliance (referred to herein as an “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine in the customer environment, and the two communicate over a public network, such as the Internet. In addition, the agent platform appliance and the management appliances communicate with each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the agent platform appliance, for example, through respective agents of the cloud services that are deployed on the agent platform appliance.

One or more embodiments provide a method of exchanging messages between an SDDC and a cloud platform through a plurality of agents deployed on an agent platform appliance that is connected to a management network of the SDDC, to enable the cloud platform to deliver cloud services to the SDDC. The method includes the steps of: acquiring an access token from a first agent of the plurality of agents, communicating with a message broker cloud service using the access token to exchange messages with the message broker cloud service, the exchanged messages including a first message from one of the cloud services to one or more of the plurality of agents and a second message from a second agent of the plurality of agents to one of the cloud services and delivering the first message to the one or more agents.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a computer system in which embodiments may be implemented.

FIG. 2 is a flow diagram of steps performed by a message broker agent, an identity agent, and a cloud authentication service to carry out a method of acquiring an access token for authenticating with a message broker service.

FIG. 3 is a flow diagram of steps performed by the message broker agent and the message broker service to carry out a method of exchanging messages.

FIG. 4 is a flow diagram of steps performed by the message broker agent to carry out a method of providing cloud-to-agent messages to intended recipients.

### DETAILED DESCRIPTION

Techniques for securely exchanging messages between a tenant's SDDCs and a cloud platform are described. According to embodiments, an agent platform appliance is deployed in a customer environment of the tenant, the customer environment including one or more SDDCs with management software for the SDDCs executing therein. The agent platform appliance is connected to the same management network as management appliances on which the management software is deployed. To connect the tenant's SDDCs to cloud services of the cloud platform, agents are deployed on the agent platform appliance. The agents perform various functionalities, including transmitting commands to the management software of the SDDCs, acquiring authentication tokens for authenticating with the management software, and acquiring access tokens for authenticating with the cloud services.

Communications between the agent platform appliance and the cloud platform are authenticated using tokens (hereinafter referred to as “access tokens”). Furthermore, communications between the agent platform appliance and the SDDCs are authenticated using tokens (hereinafter referred to as “authentication tokens”). Accordingly, through the agent platform appliance, the cloud platform delivers cloud services to the management software.

Communications between the agent platform appliance and the cloud platform are facilitated by a “message broker agent” of the agent platform appliance and a “message broker service” of the cloud platform. To communicate with the cloud services, agents of the agent platform appliance transmit messages to the message broker agent (hereinafter referred to as “agent-to-cloud” messages). Similarly, to communicate with the cloud service agents, cloud services transmit messages to the message broker service (hereinafter referred to as “cloud-to-agent” messages). The message broker agent then initiates an exchange of messages with the cloud broker service, the message broker agent exchanging agent-to-cloud messages for cloud-to-agent messages.

Because the message broker agent initiates the communications with the cloud platform, network configurations of the SDDCs such as firewall settings do not need to be updated to account for incoming messages from the cloud platform. Furthermore, when other agents of the agent platform appliance transmit messages to the message broker agent, the communication is through well-known APIs such as hypertext transfer protocol (HTTP) APIs. Accordingly, the agent-to-cloud messages need not be structured, e.g., according to APIs of the cloud services. The techniques described herein are thus seamless. These and further aspects of the invention are discussed below with respect to the drawings.

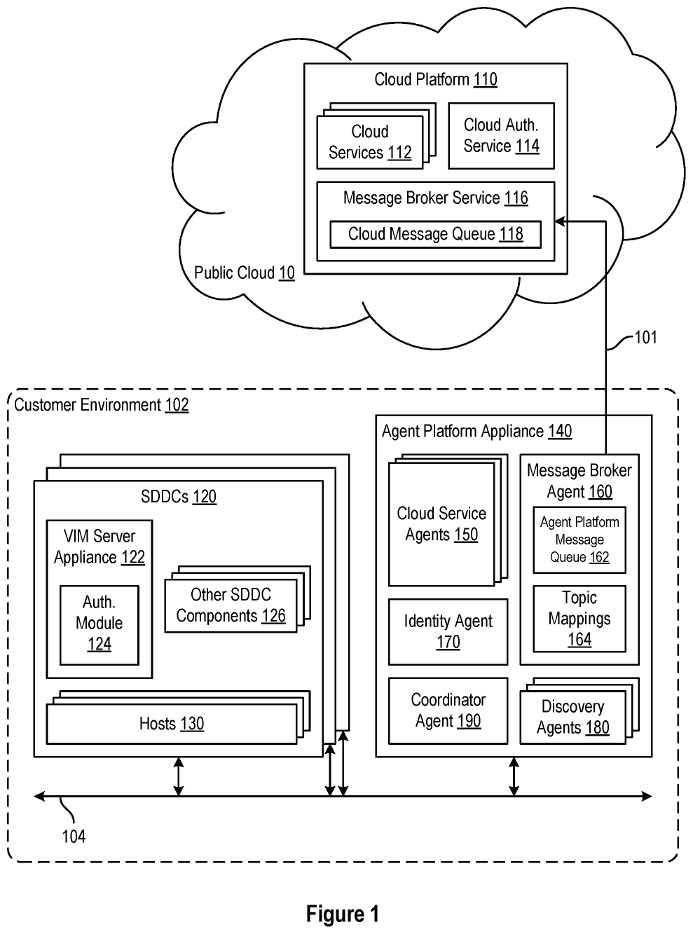

FIG. 1 is a block diagram of a computer system in which embodiments may be implemented. The computer system includes a multi-tenant cloud platform 110 deployed in a public cloud 10, and a customer environment 102 in which SDDCs 120 of a particular tenant are deployed. Communications between cloud platform 110 and SDDCs 120 are carried out via an agent platform appliance 140 of customer environment 102. Communications between cloud platform 110 and agent platform appliance 140 are carried out over a public network 101 such as the Internet.

Each of SDDCs 120 includes hosts 130, hosts 130 being constructed on server grade hardware platforms (not shown) such as x86 architecture platforms. Hosts 130 include conventional components of computing devices (not shown), such as one or more central processing units (CPUs), memory such as random-access memory (RAM), local storage such as one or more magnetic drives or solid-state drives (SSDs) and/or a host bus adapter for connection to a storage area network, and one or more network interface cards (NICs). The NIC(s) enable hosts 130 to communicate with each other and with other devices over a management network 104. Hosts 130 include software platforms including hypervisors (not shown), which are virtualization software layers that support VM execution spaces (not shown) within which VMs are concurrently instantiated and executed. Each of SDDCs 120 also includes additional hardware devices (not shown) such as shared storage and networking devices.

Each of SDDCs 120 includes a VIM server appliance 122 and other SDDC components 126 each running various management software. VIM server appliance 122 logically groups hosts 130 into a cluster to perform cluster-level tasks such as provisioning and managing VMs and migrating VMs from one host 130 to another. One example of VIM server appliance 122 is a VMware vCenter Server® appliance from VMware, Inc. Other SDDC components 126 provide other management functionalities such as provisioning virtual networking resources. An example of one of other SDDC components 126 is a VMware NSX ° appliance from VMware, Inc.

VIM server appliance 122 and other SDDC components 126 communicate via management network 104, and the various management software running thereon are referred to collectively herein as “management software.” Management network 104 is distinguishable from public network 101 in that it is a private network, e.g., a local area network or a sub-net, and is partitioned from public network 101 through a firewall. In some embodiments, each of the SDDC components including VIM server appliance 122 is a VM instantiated on one or more of hosts 130. In other embodiments, each of the SDDC components may be implemented as a physical host having the conventional hardware platform described above with respect to hosts 130.

VIM server appliance 122 includes an authentication module 124, which authenticates requests for access. When it is able to authenticate such requests, authentication module 124 issues role-based authentication tokens such as Security Assertions Markup Language (SAML) tokens. Each authentication token allows a party possessing the token to access VIM server appliance 122 to perform an operation on VIM server appliance 122 that is associated with the issued token. Other SDDC components 126 similarly each include an authentication module (not shown), which issues role-based authentication tokens for requesting parties. For security purposes, authentication tokens each have a specified time-to-live (TTL), after which the tokens expire.

Cloud platform 110 is provisioned in public cloud 10, and public cloud 10 is operated by a cloud computing service provider from a plurality of physical host computers (not shown). Cloud platform 110 includes cloud services 112, a cloud authentication service 114, and a message broker service 116. Cloud services 112 include an SDDC configuration service, an SDDC upgrade service, an SDDC monitoring service, and an SDDC inventory service. Message broker service 116 provides a method of communicating securely with cloud services 112, as discussed further below.

Cloud authentication service 114 enables authentication with message broker service 116. To enable such authentication, cloud authentication service 114 issues access tokens such as JavaScript Object Notation (JSON) web tokens (JWTs). Each access token allows a requesting party to interface with cloud services 112 through message broker service 116, as discussed below. It should be noted that although cloud authentication service 114 is illustrated as being within cloud platform 110, cloud authentication service 114 may run on a virtual or physical server that is not part of cloud platform 110. For security purposes, access tokens each have a specified TTL, after which the tokens expire.

Agent platform appliance 140 is, e.g., a physical server, or a VM deployed on a host similar to hosts 130, the host including a CPU(s) configured to execute instructions such as executable instructions that perform one or more operations described herein and including memory in which such executable instructions are stored. Agent platform appliance 140 is also connected to management network 104 such that agent platform appliance 140 and SDDCs 120 are on the same side of a firewall (not shown) of customer environment 102. As a result, communications between agent platform appliance 140 and SDDCs 120 are secure and protected from attacks originating from outside customer environment 102 such as snooping attacks.

On agent platform appliance 140, various agents are deployed, including cloud service agents 150, a message broker agent 160, an identity agent 170, discovery agents 180, and a coordinator agent 190. The agents on agent platform appliance 140 communicate with each other, e.g., through HTTP APIs. The agents on agent platform appliance 140 also communicate with SDDCs 120 and cloud platform 110, as discussed further below.

Cloud service agents 150, which correspond to cloud services 112, issue commands to the management software of SDDCs 120 and report results of operations to cloud services 112. To communicate with cloud services 112, cloud service agents 150 transmit agent-to-cloud messages to message broker agent 160. Each agent-to-cloud message includes the name of one of cloud services 112, which is the intended recipient. Message broker agent 160 temporarily stores agent-to-cloud messages in an agent platform message queue 162.

Similarly, cloud services 112 transmit cloud-to-agent messages to message broker service 116, which message broker service 116 temporarily stores in queues corresponding to various tenants, including a cloud message queue 118 corresponding to the tenant of SDDCs 120. In some cases, a cloud-to-agent message includes the name of one of cloud service agents 150 as the intended recipient. In other cases, a cloud-to-agent message includes the name of a topic that one or more of cloud service agents 150 are subscribed to. Accordingly, message broker agent 160 manages topic mappings 164, which store a list of topics and, for each topic, one or more names of cloud service agents 150 subscribed to the topic. The intended recipient(s) of such messages are all cloud service agents 150 subscribed to the specified topic. In other cases, a cloud-to-agent message includes an indicator of being a broadcast message. The intended recipients of broadcast messages are all of cloud service agents 150.

To provide agent-to-cloud messages to cloud services 112 and cloud-to-agent messages to cloud service agents 150, message broker service 116 and message broker agent 160 exchanges messages, e.g., periodically. Specifically, message broker agent 160 initiates the exchange with message broker service 116. Message broker agent 160 transmits agent-to-cloud messages from agent platform message queue 162, to message broker service 116, which forwards them to cloud services 112. In exchange, message broker service 116 transmits cloud-to-agent messages from cloud message queue 118, to message broker agent 160, which forwards them to cloud service agents 150.

Identity agent 170 is deployed on agent platform appliance 140 to acquire access tokens from cloud authentication service 114. Identity agent 170, when deployed, is given access to a private key of the tenant (not shown) and transmits a challenge phrase that is signed with the private key as payload for authenticating with cloud authentication service 114. In response, cloud authentication service 114 decrypts the payload using a public key of the tenant and issues an access token for the tenant if the decrypted payload matches the challenge phrase. The access token enables message broker agent 160 to authenticate with cloud platform 110.

Discovery agents 180 are deployed on agent platform appliance 140 to manage communications with the management software of SDDCs 120. Each of discovery agents 180 corresponds to one type of management software for all of SDDCs 120. Agents 150 request authentication tokens from discovery agents 180. Each of discovery agents 180 then communicates with its respective SDDC components, such as VIM server appliance 122, to acquire the authentication tokens. Discovery agents 180 then provide the authentication tokens to agents 150, which agents 150 use to authenticate with the management software and to transmit commands thereto.

In one embodiment, each of the cloud services is a microservice that is implemented as one or more container images executed on a virtual infrastructure of public cloud 10. Similarly, each of the agents deployed on agent platform appliance 140 is a microservice that is implemented as one or more container images executing in agent platform appliance 140.

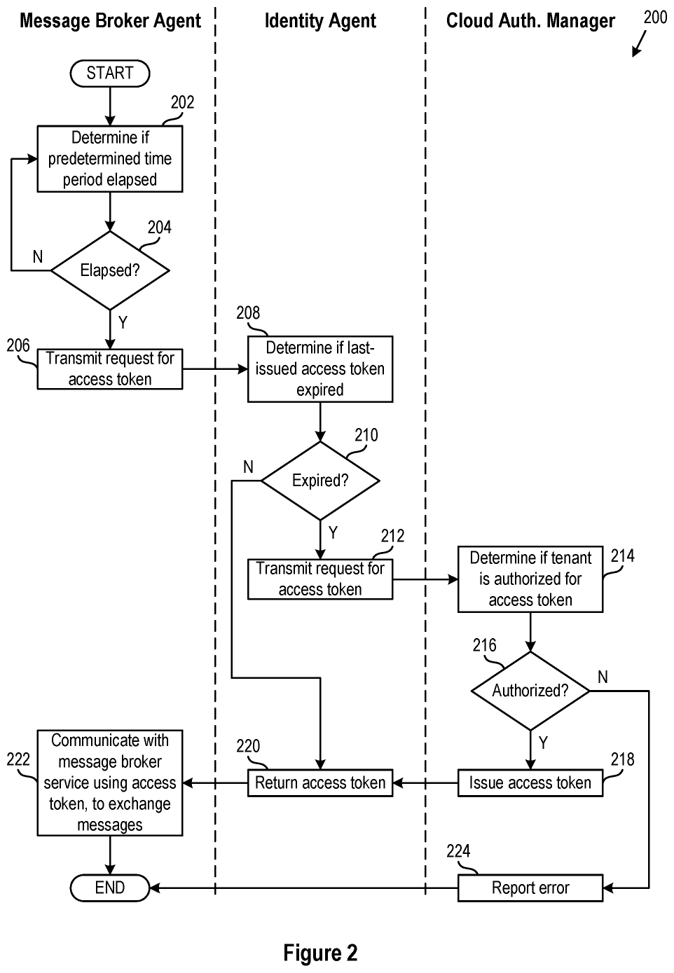

FIG. 2 is a flow diagram of steps performed by message broker agent 160, identity agent 170, and cloud authentication service 114 to carry out a method 200 of acquiring an access token for authenticating with message broker service 116. At step 202, message broker agent 160 determines if a predetermined time period has elapsed, e.g., since a previous message exchange. At step 204, if the time period has not elapsed, method 200 returns to step 202, and message broker agent 160 continues waiting for the time period to elapse. Otherwise, if the time period has elapsed, method 200 moves to step 206.

At step 206, message broker agent 160 transmits a request to identity agent 170 for an access token. At step 208, identity agent 170 determines if the last access token (if any) acquired by identity agent 170 is expired, i.e., if the TTL thereof has lapsed. At step 210, if the last-issued access token is still active, method 200 moves to step 220. Otherwise, if the last-issued access token has expired (or if identity agent 170 has not yet acquired an access token), method 200 moves to step 212. At step 212, identity agent 170 transmits a request to cloud authentication service 114 for a new access token, the request including a payload containing the challenge phrase that is digitally signed using the private key of the tenant, as described above.

At step 214, cloud authentication service 114 determines if the tenant is authorized for an access token by decrypting the payload in the request using the public key of the tenant and confirming the challenge phrase in the manner described above. At step 216, if the tenant is authorized, method 200 moves to step 218, and cloud authentication service 114 issues a new access token to identity agent 170. At step 220, identity agent 170 returns an access token to message broker agent 160, the access token being either a previously issued access token determined to be active at step 210 or an access token issued at step 218.

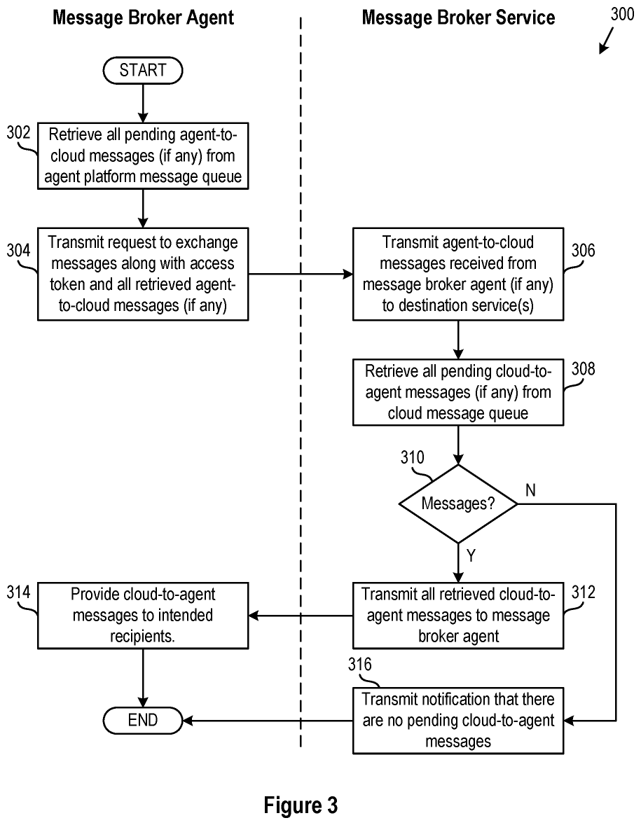

At step 222, message broker agent 160 communicates with message broker service 116 using the access token, to exchange messages, as discussed further below in conjunction with FIG. 3. The access token authenticates that message broker agent 160 is authorized to transmit messages to cloud platform 110. After step 222, method 200 ends. Returning to step 216, if the tenant is not authorized, method 200 moves to step 224. At step 224, cloud authentication service 114 reports an error, notifying identity agent 170 that the new access token cannot be issued. After step 224, method 200 ends. It should be noted that although method 200 illustrates message broker agent 160 initiating an exchange of messages periodically, message broker agent 160 may also determine to exchange messages, e.g., each time it receives an agent-to-cloud message from one of cloud service agents 150.

FIG. 3 is a flow diagram of steps performed by message broker agent 160 and message broker service 116 to carry out a method 300 of exchanging messages. At step 302, message broker agent 160 retrieves all pending agent-to-cloud messages (if any) from agent platform message queue 162. At step 304, message broker agent 160 transmits a request to exchange messages, to message broker service 116, including an access token corresponding to the tenant returned at step 218 of method 200. Message broker agent 160 also transmits all pending agent-to-cloud messages retrieved from agent platform message queue 162 (if any) and clears agent platform message queue 162 of any agent-to-cloud messages.

At step 306, message broker service 116 transmits any agent-to-cloud messages received from message broker agent 160, to the intended recipients. As previously stated, each agent-to-cloud message includes a name of one of cloud services 112 as the intended recipient. At step 308, message broker service 116 retrieves all pending cloud-to-agent messages (if any) from cloud message queue 118. At step 310, if there is at least one pending cloud-to-agent message retrieved at step 308, method 300 moves to step 312. At step 312, message broker service 116 transmits each retrieved cloud-to-agent message to message broker agent 160 and clears cloud message queue 118 of any cloud-to-agent messages.

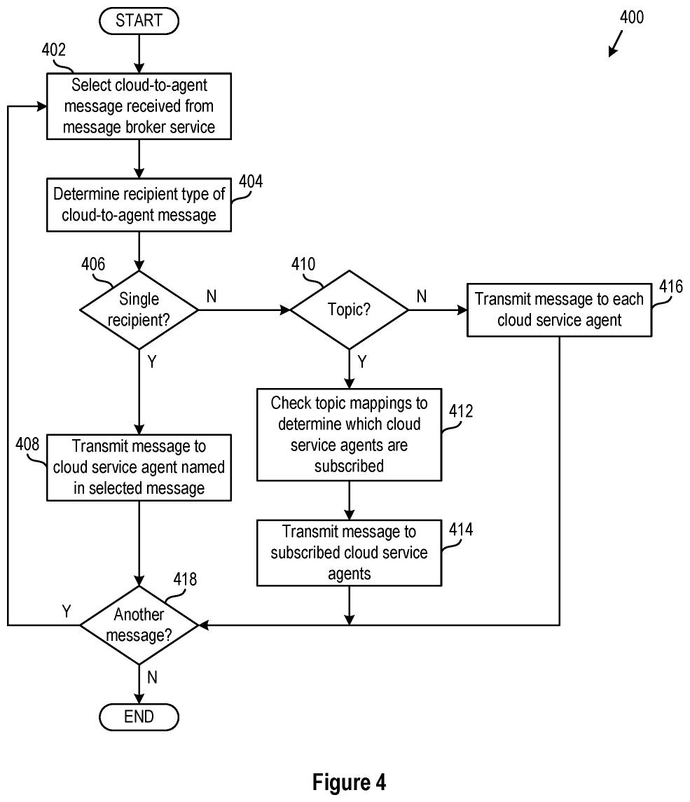

At step 314, message broker agent 160 provides the cloud-to-agent messages to the intended recipients, as discussed further below in conjunction with FIG. 4. After step 314, method 300 ends. Returning to step 310, if there were no pending cloud-to-agent messages in cloud message queue 118, method 300 moves to step 316. At step 316, message broker service 116 transmits a notification to message broker agent 160 indicating that there are no pending cloud-to-agent messages. After step 316, method 300 ends.

FIG. 4 is a flow diagram of steps performed by message broker agent 160 to carry out a method 400 of providing cloud-to-agent messages to intended recipients. At step 402, message broker agent 160 selects a cloud-to-agent message received from message broker service 116. At step 404, message broker agent 160 determines the recipient type of the selected cloud-to-agent message. As previously mentioned, a cloud-to-agent message may include, as the recipient, the name of one of cloud service agents 150, the name of a topic that one or more of cloud service agents 150 are subscribed to, or an indication that the cloud-to-agent message is a broadcast message.

At step 406, if the cloud-to-agent message includes the name of one of cloud service agents 150 as a single intended recipient, method 400 moves to step 408. At step 408, message broker agent 160 transmits the message to the named one of cloud service agents 150. Returning to step 406, if the cloud-to-agent message includes a different type of recipient than a single, named recipient, method 400 moves to step 410.

At step 410, if the message includes a topic, method 400 moves to step 412. At step 412, message broker agent 160 checks topic mappings 164 to determine which cloud service agents 150 are subscribed to the topic. At step 414, message broker agent 160 transmits the message to each of subscribed cloud service agents 150. Returning to step 410, if the d oud-to-agent message is designated as a broadcast message, method 400 moves to step 416.

At step 416, message broker agent 160 transmits the message to each of cloud service agents 150. At step 418, if there is another cloud-to-agent message received from message broker service 116, method 400 returns to step 402, and message broker agent 160 selects another message. Otherwise, if there is not another message, method 400 ends.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are hard disk drives (HDDs), SSDs, network-attached storage (NAS) systems, read-only memory (ROM), random-access memory (RAM), compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of exchanging messages between a software-defined data center (SDDC) and a cloud platform through a plurality of agents deployed on an agent platform appliance that is connected to a management network of the SDDC, to enable the cloud platform to deliver cloud services to the SDDC, the method comprising:
acquiring an access token from a first agent of the plurality of agents;
communicating with a message broker cloud service using the access token to exchange messages with the message broker cloud service, the exchanged messages including a first message from one of the cloud services to one or more of the plurality of agents and a second message from a second agent of the plurality of agents to one of the cloud services; and
delivering the first message to the one or more agents.

2. The method of claim 1, further comprising:
acquiring agent-to-cloud messages, including the second message, from one or more of the plurality of agents and storing the agent-to-cloud messages in a first message queue, wherein
said communicating with the message broker cloud service is carried out at periodic intervals, and at each of the periodic intervals, an of the agent-to-cloud messages stored in the first message queue are transmitted to the message broker cloud service and then removed from the first message queue.

3. The method of claim 2, wherein
the message broker cloud service maintains a second message queue that contains cloud-to-agent messages that are to be transmitted from the cloud services to one or more of the plurality of agents, and
at each of the periodic intervals, all of the cloud-to-agent messages stored in the second message queue are transmitted to the message broker agent and then removed from the second message queue.

4. The method of claim 1, further comprising:
prior to delivering the first message to the one or more agents of the plurality of agents, determining that the first message includes a topic and that the one or more agents of the plurality of agents are subscribed to the topic.

5. The method of claim 4, further comprising:
tracking for each of a plurality of topics, which of the plurality of agents are subscribed thereto.

6. The method of claim 1, further comprising:
determining that the first message contains a name of a third agent of the plurality of agents,
wherein the first message is only delivered to the third agent.

7. The method of claim 1, further comprising:
determining that the first message is a broadcast message to be transmitted to each of the plurality of agents that corresponds to one of the cloud services,
wherein the first message is delivered to each of the plurality of agents that corresponds to one of the cloud services.

8. A non-transitory computer-readable medium comprising instructions that are executable in a computer system, wherein the instructions when executed cause the computer system to carry out a method of exchanging messages between a software-defined data center (SDDC) and a cloud platform through a plurality of agents deployed on an agent platform appliance that is connected to a management network of the SDDC, to enable the cloud platform to deliver cloud services to the SDDC, the method comprising:
acquiring an access token from a first agent of the plurality of agents,
communicating with a message broker cloud service using the access token to exchange messages with the message broker cloud service, the exchanged messages including a first message from one of the cloud services to one or more of the plurality of agents and a second message from a second agent of the plurality of agents to one of the cloud services; and
delivering the first message to the one or more agents.

9. The non-transitory computer-readable medium of claim 8, the method further comprising:
acquiring agent-to-cloud messages, including the second message, from one or more of the plurality of agents and storing the agent-to-cloud messages in a first message queue, wherein
said communicating with the message broker cloud service is carried out at periodic intervals, and at each of the periodic intervals, all of the agent-to-cloud messages stored in the first message queue are transmitted to the message broker cloud service and then removed from the first message queue.

10. The non-transitory computer-readable medium of claim 9, wherein
the message broker cloud service maintains a second message queue that contains cloud-to-agent messages that are to be transmitted from the cloud services to one or more of the plurality of agents, and
at each of the periodic intervals, all of the cloud-to-agent messages stored in the second message queue are transmitted to the message broker agent and then removed from the second message queue.

11. The non-transitory computer-readable medium of claim 8, the method further comprising:
prior to delivering the first message to the one or more agents of the plurality of agents, determining that the first message includes a topic and that the one or more agents of the plurality of agents are subscribed to the topic.

12. The non-transitory computer-readable medium of claim 11, the method further comprising:
tracking for each of a plurality of topics, which of the plurality of agents are subscribed thereto.

13. The non-transitory computer-readable medium of claim 8, the method further comprising:
determining that the first message contains a name of a third agent of the plurality of agents,
wherein the first message is only delivered to the third agent.

14. The non-transitory computer-readable medium of claim 8, the method further comprising:
determining that the first message is a broadcast message to be transmitted to each of the plurality of agents that corresponds to one of the cloud services,
wherein the first message is delivered to each of the plurality of agents that corresponds to one of the cloud services.

15. A computer system comprising a plurality of servicers, the plurality of servers including an agent platform appliance connected to a management network of a software-defined data center (SDDC), and the agent platform appliance including a plurality of agents deployed thereon, wherein a message broker agent of the plurality of agents is configured to:
acquire an access token from a first agent of the plurality of agents;
communicate with a message broker cloud service of a cloud platform, using the access token to exchange messages with the message broker cloud service, the exchanged messages including a first message from a cloud service of the cloud platform to one or more of the plurality of agents and a second message from a second agent of the plurality of agents to a cloud service of the cloud platform; and
deliver the first message to the one or more agents.

16. The computer system of claim 15, wherein the message broker agent is further configured to:
acquire agent-to-cloud messages, including the second message, from one or more of the plurality of agents and storing the agent-to-cloud messages in a first message queue, wherein
said communicating with the message broker cloud service is carried out at periodic intervals, and at each of the periodic intervals, all of the agent-to-cloud messages stored in the first message queue are transmitted to the message broker cloud service and then removed from the first message queue.

17. The computer system of claim 16, wherein
the message broker cloud service maintains a second message queue that contains cloud-to-agent messages that are to be transmitted from the cloud services to one or more of the plurality of agents, and
at each of the periodic intervals, all of the cloud-to-agent messages stored in the second message queue are transmitted to the message broker agent and then removed from the second message queue.

18. The computer system of claim 15, wherein the message broker agent is further configured to:
prior to delivering the first message to the one or more agents of the plurality of agents, determine that the first message includes a topic and that the one or more agents of the plurality of agents are subscribed to the topic.

19. The computer system of claim 18, wherein the message broker agent is further configured to:
track for each of a plurality of topics, which of the plurality of agents are subscribed thereto.

20. The computer system of claim 15, wherein the message broker agent is further configured to:
determine that the first message contains a name of a third agent of the plurality of agents,
wherein the first message is only delivered to the third agent.
